(19) United States
(12) Patent Application Publication
(10) Pub. No.: US 2014/0180473 A1
(43) Pub. Date: Jun. 26, 2014

(54) METHOD FOR OPERATING AT LEAST ONE VENDING MACHINE

(71) Applicant: MFL Suisse GmbH, Bern (CH)

(72) Inventors: Joerg OTZEN, Le Mont-Pelerin (CH); Thomas MEIER, Erlinsbach (CH)

(73) Assignee: MFL Suisse GmbH, Bern (CH)

(21) Appl. No.: 14/193,408

(22) Filed: Feb. 28, 2014

Related U.S. Application Data
(63) Continuation of application No. PCT/EP2012/065653, filed on Aug. 10, 2012.

(30) Foreign Application Priority Data
Aug. 29, 2011 (DE) 10 2011 081 751.4

(51) Int. Cl. G07F 11/00

(52) U.S. Cl. CPC G07F 11/002
USPC 700/232

(57) ABSTRACT

A method for operating at least one vending machine. A food product to be prepared by the vending machine and dispensed to a consumer is remotely ordered by the consumer over at least one wireless and/or wired communications link, the order being transmitted to the vending machine over the same or another wireless and/or wired communications link.

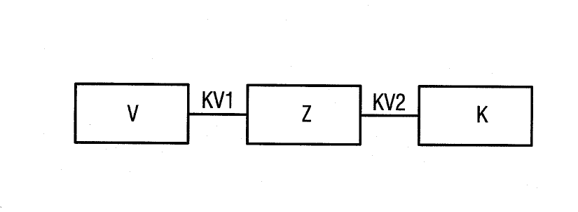

This nonprovisional application is a continuation of International Application No. PCT/EP2012/065653, which was filed on Aug. 10, 2012, and which claims priority to German Patent Application No. 10 2011 081 751.4, which was filed in Germany on Aug. 29, 2011, and which are both herein incorporated by reference.

### BACKGROUND OF THE INVENTION

1. Field of the Invention

The present invention relates to a method for operating at least one vending machine.

2. Description of the Background Art

Vending machines are known from the prior art, in which food products may be prepared and output to a consumer.

An automated inventory control system and a remote ordering device which may be used in this inventory control system are described in WO 97/28510 A1. The automated inventory control system comprises a plurality of remote ordering devices by means of which a user may identify himself and order a product in a remote location or determine a local location where the product is available.

An electronic remote retailing system having an ordering device is known from WO 99/09508 A1. The orders may also be placed over a communications network.

### SUMMARY OF THE INVENTION

It is therefore an object of the present invention to provide a method for operating at least one vending machine.

In a method for operating at least one vending machine, according to an embodiment of the invention, a food product to be prepared by the vending machine and dispensed to a consumer is remotely ordered by the consumer over at least one wireless and/or wired communications link, the order being transmitted to the vending machine over the same or another wireless and/or wired communications link. The particular communications link may have both wired and wireless sections.

The vending machine is remotely operated or remote-controlled directly or indirectly by the consumer, i.e., the consumer communicates with the vending machine directly or indirectly, for example via a central unit of a vending service provider, i.e., and operator of a plurality of these vending machines, the central unit being designed, for example, as a host computer or server. The central unit then forwards the ordering information of the consumer to the particular vending machines, likewise over a wireless and/or wired communications link. Remotely operated, remote-controlled or a remote order means that the consumer is in a geographic location other than the location of the vending machine during the ordering process, so that he has no physical contact with the vending machine in order to operate the vending machine with the aid of control elements disposed thereon.

Communication via a central unit is particularly advantageous, since a network having a plurality of vending machines may be formed thereby, each of which is connected to the central unit in a wired manner or particularly preferably wirelessly. The network may be designed, for example, as a master/slave network, the central unit being the master and the vending machines connected thereto being the slaves. However, other network configurations are also possible. With the aid of a network of this type, the consumer gains access to all vending machines in the network and may, for example, select for his order the vending machine in the most favorable location for the consumer or the vending machine having the food product desired by the consumer or the vending machine having the most attractive food product price.

The communications links between the vending machines and the central unit are preferably designed to be bidirectional, so that information may be transmitted from the vending machine to the central unit via this network, for example information about a current fill status with respect to the food products, which are identifiable, for example, on the basis of a lot number. The dispensing time of the food products and the particular type of food product dispensed may furthermore be transmitted to the central unit, so that a demand and its distribution over time as well as product selection of the vending machine, for example, may be monitored at any time in the central unit. The filling of the vending machines with new food products may then be planned in a timely fashion on the basis of the data transmitted by the vending machine, for example on the fill status. During filling, the filled food products are advantageously scanned, for example using bar codes, and reported to the central unit.

The method makes it possible for the consumer to place his order when he is still at a great distance from the vending machine, so that the time it takes for the consumer to reach the vending machine, i.e. the period of time the consumer needs to Cover a distance to the vending machine, may be used in this manner to prepare the food product. In particular, a heating of food products, particularly if they are stored in frozen form in the vending machine, requires a longer preparation time, for example for defrosting, heating and furthermore possibly for cooking the food product. Due to the remote ordering process, therefore, the consumers avoid long waiting times at the vending machine.

Moreover, the consumer is easily informed of which food products are sold in the vending machine and for what price. The consumer thus avoids unnecessary trips to the vending machine, since he goes to the vending machine only if the order was successful and not if the vending machine does not offer the food products the consumer wishes to have.

The consumer preferably orders the food product over an Internet connection and/or over a mobile communications link. For example, this order may take place via a mobile or stationary computer or a mobile telephone, either by direct access to the particular vending machine by access to the central unit, for example of a particular vending service provider. If the order is placed over the Internet, a website, for example, is made available to the consumer by the central unit, which the consumer may use to enter his order on an appropriate input screen. Alternatively, it is also possible, for example, to place the order over the phone, the order then being transmitted by an order handler to the central unit or directly to the vending machine over an appropriate communications link.

The consumer advantageously registers on a one-time basis to permit orders to be placed by transmitting user data and/or by installing an ordering program on a mobile or stationary computer or a mobile phone. This is a one-time registration process for the consumer, i.e., the consumer registers in this manner as a user of the method or the ordering system and may thereafter be always uniquely identified by logging in with his registered user data, i.e., by logging in with his registered user data, for example, on a website of the vending service provider or by activating the ordering program. An ordering program of this type may be, for example, a so-called app, i.e., a corresponding application program which is installed, in particular, on mobile phones designed as so-called smart phones. If the consumer registers by transmitting user data, for example to the central unit, the transmission being able to take place, for example over the Internet, for example via a website of the central unit having a corresponding input screen, or, for example also over the phone, for example via a so-called call center, the consumer's last name and first name, date of birth, mobile number, e-mail address, preferred method of payment and/or a declaration of consent with respect to use conditions, for example, being collected as user data. In particular, the permission of the consumer is necessary if, for example, a current position of the consumer is to be determined, for example using mobile telephone geolocation.

During the one-time registration, the consumer is assigned, for example, a unique customer number which may be used to identify him when he places an order. Other or additional identifying features may also be, for example, his transmitted user data, in particular his e-mail address and/or his name and/or his date of birth. If an order is placed via the installed ordering program, the consumer's mobile phone, for example, may be used for identification, for example by transmitting his mobile number and/or an identifier of a SIM card installed in the mobile phone.

By specifying the user data, a customer account, for example, may also be created, in which points or cash amounts, for example, may be credited to the consumer, depending on his orders. The consumer may also be notified of discounts, for example, via his mobile phone or e-mail address.

Credit card payments, direct debits, bank transfers, payments via an online payment system with or without using the mobile phone, for example billing via a mobile phone bill, are possible as preferred means of payment or payment options. The payment is advantageously made immediately at the time the order is placed, advantageously automatically by using the preferred means of payment specified by the consumer. In this manner, the order is carried out only after payment, which prevents, for example, the vending machine from becoming clogged with prepared food products waiting to be dispensed if the consumer fails to pay. Alternatively, of course, the consumer also has the option, for example, of paying cash directly at the vending machine immediately before the food product is dispensed. In this case, however, the danger of the vending machine becoming clogged arises if the consumer is unable to pay and the food product may therefore be retained in the vending machine.

A type of food product, a time at which the food product is dispensed from the vending machine and/or a location of the vending machine where the order is to be processed are preferably requested as order attributes and specified by the consumer. The order attributes are requested automatically if the installed ordering program is used, so that the consumer may enter the applicable order attributes. If an order is placed over the Internet, for example on the website of the central unit, an input screen for accepting the order includes corresponding input fields to be filled in. If an order is placed over the telephone, for example via a call center, the consumer is asked for these order attributes over the telephone, the information provided by the consumer is collected and entered, for example in the central unit. In this manner, the consumer may select, for example, a vending machine which he is able to reach quickly and conveniently, which offers his preferred food products or which offers a particularly attractive food product price. The indication of the dispensing time allows the preparation of the food product to begin in such a way that it is finished when the dispensing time is reached. This avoids the consumer having to wait for a long time at the vending machine. This furthermore avoids the vending machine becoming clogged by a food product which is prepared too early and which then remains in the dispensing compartment of the vending machine until the consumer picks it up, thereby preventing additional food products from being dispensed. A fresh preparation of the food product is also ensured thereby, so that an optimum temperature is ensured and, for example, the food product does not have to be kept warm. This makes it unnecessary to provide, for example, a unit for storing and keeping food warm in the vending machine, so that the vending machine may have a simpler, smaller and more economical design.

Information about the current status of his order is preferably transmitted to the consumer. This information may be sent to the consumer over the communications link over which he ordered the food product or over another communications link. As a result, the consumer preferably receives an order confirmation to verify his order immediately after the order is placed, for example by e-mail or in the form of a message transmitted to his mobile phone, for example an SMS text message. Additional information may furthermore be sent to the consumer, the consumer being able to select this information, for example, when placing the order or during the one-time registration process.

For example, reminder messages are thus transmitted to the consumer in order to thereby ensure that he picks up the food product which he has ordered and which was prepared by the vending machine in good time to prevent the vending machine from being clogged thereby. A point in time for a reminder message of this type may be specified, for example 15 minutes before the dispensing time of the food product, or it may be defined by the consumer. This reminder message may also be transmitted to the consumer, for example as an e-mail or SMS text message.

The consumer is furthermore preferably notified if the dispensing time he has requested cannot be met, for example due to particularly high demand, since other orders must first be processed. In this case, the consumer is preferably notified of a new dispensing time for his food product, so that he does not have to wait unnecessarily at the vending machine for his food product.

According to an embodiment of the invention, a current position of the consumer is determined. This may be done, for example, by determining the position of his mobile phone, for example via a position determining function of his mobile telephone with the aid of a global navigation satellite system for determining the position or with the aid of a position determining system by determining cells of a mobile network where the mobile telephone is currently registered. The determined position is then transmitted from the consumer's mobile phone to the central unit or directly to the vending machine. To determine the consumer's position by determining the cells of the mobile network where the consumer's mobile phone is currently registered, the central unit may access, for example, information of a mobile network carrier.

In this manner, it may be established in an embodiment according to the invention whether it will be possible for the consumer to reach the vending machine he selected while placing the order by the dispensing time he specified while placing the order. In this embodiment according to the invention, the consumer is thereby warned if he is too far away from a selected vending machine to reach the vending machine before the time he has specified for dispensing the food product. In other words, the determined current position of the consumer is used to predict a point in time at which the consumer will reach an vending machine he has selected. This predicted point in time is automatically compared with the dispensing time specified by the consumer, and the consumer is automatically warned if the predicted point in time is later than the dispensing time he has specified.

The warning is advantageously given during the placement of the order in the form of a corresponding alert. This makes it possible to cancel or reject the order, or at least to adjust the dispensing time accordingly, or another vending machine may be selected which the consumer is able to reach more quickly. In other words, the position determining function and the prediction of the point in time at which the consumer would reach the vending machine are carried out during the ordering process.

In an alternative or additional embodiment according to the invention, the preparation of the food product in the vending machine is not started until the consumer has reached or is closer than a predefined distance from the vending machine. This is particularly advantageous when using the function for determining the position of the consumer, since in this case no fixed time for dispensing the food product needs to be specified, and instead the preparation of the food product is not started until the consumer has reached a sufficient distance from the vending machine to allow the consumer to pick up the food product at the vending machine in this manner as soon as possible after the preparation has finished. This is made possible, for example, by redetermining the consumer's position continuously or at predetermined time intervals and transmitting it to the central unit or the vending machine via the consumer's mobile phone.

In this manner, a clogging of the vending machine by a prepared food product which is waiting in the dispensing compartment to be picked up by the consumer and which will be picked up only with a long delay because the consumer is too far away from the vending machine. This would hinder, i.e., cause a delay in processing, subsequent orders by the vending machine and thereby inconvenience other consumers. In addition, the prepared food product would get cold in the dispensing compartment. This is prevented by preparing the food product in coordination with the position of the consumer. Moreover, this means that no unit for storing and keeping food warm needs to be provided in the vending machine, so that the vending machine may have a smaller, simpler and more economical design.

This approach also makes optimum use of the vending machine, since the orders are not processed according to their receipt or according to the dispensing time specified by the consumer but rather according to the proximity of the particular consumer to the vending machine. In other words, the system processes the order of the consumer who is located the shortest distance from the vending machine and who is therefore able to pick up the finished food product ready for dispensing the soonest. This reduces the waiting times for the consumers or eliminates them entirely.

According to an embodiment of the invention, these advantages may also be alternatively or additionally achieved by the fact that the time for dispensing the food product from the vending machine is predicted with the aid of the determined current position of the consumer. This time corresponds to the predicted point in time at which the consumer reaches the vending machine. Taking into account the preparation time needed to prepare the food product, the preparation of the food product is then started in good time before the predicted dispensing time. This has the advantage that the position of the consumer does not have to be determined constantly or multiple times. For example, a one-time position determination is enough. A multiple or continuous position determination is, of course, advantageous in order to check the prediction of the dispensing time and make it more precise, in order to thereby enable the preparation to start on time and to optimize the dispensing time of the food product. As a result, the preparation of the food product has preferably finished by the time the consumer arrives at the vending machine, and the food product is dispensed to the consumer, so that no waiting time arises for the consumer, and the vending machine is not clogged with food products that have not yet been picked up. Once again, the orders may be processed by the vending machine in the order of the predicted dispensing times.

A food product price is preferably determined as a function of at least one predefined parameter and communicated to the consumer during the ordering process, i.e., transmitted over the communications link. This is an alternative to a predefined fixed price at which the submitted orders are then processed in sequence. This may result in longer waiting times for the consumers, particularly if there is high demand. Adjusting the food product price, for example, to the particular selection and the particular demand may avoid this circumstance, since demand may be increased by a price reduction at times of low demand, and demand may be reduced by correspondingly increasing the price at times of high demand, thereby avoiding excessively long waiting times for the consumers.

The food product price may be different for different food products available in the vending machine, and it may be adjusted differently, so that a correspondingly lower food product price may be set, for example, for food products for which there is less demand or for food products whose sell-by date will soon expire. In a plurality of available vending machines, the food product price of the same food product may vary in different vending machines at the same time, for example depending on supply and demand in the particular vending machine. Consumers may be redirected thereby, for example to a more remote vending machine if they are prepared to travel a greater distance to pick up the food product in order to obtain it at a correspondingly more attractive food product price.

In other words, the parameters for determining the particular food product price for available food products are, for example, a particular selection of a particular food product, a particular demand for this food product, inventories of the particular food product in the vending machines and their sell-by dates as well as a location of the particular vending machine. In addition, a parameter of this type for determining the particular food product price may also be, for example, the specification of a fixed dispensing time or the variable determination of the dispensing time as a function of the current position of the consumer. In the case of high demand, in particular, it is advantageous to begin preparing the particular food product only when the consumer is located sufficiently near the vending machine to allow him to pick up the food product as soon as possible after it is prepared. If this option is selected, the food product price is therefore preferably less fixed than with a permanently predefined dispensing time, where the danger of the vending machine being clogged by a late pickup of the food product and a resulting inconvenience to subsequent consumers is much greater. In other words, if the consumers consent to have their current position determined by their mobile phone and transmitted to the central unit or directly to the vending machines, they receive the food product at a more attractive food product price.

The consumer is advantageously identified with the aid of at least one consumer identification unit for dispensing the prepared food product. This consumer identification unit may be, for example, part of the vending machine or situated in the direct vicinity of the vending machine and coupled therewith. For example, a so-called near field communication (NFC) system (German: Nahbereichskommunikation) may be used to identify the consumer. It is furthermore possible to use other wireless or wired communications links, which, however, have only a short range, in order to thereby determine that the consumer is located in the direct vicinity of the vending machine in order to remove the food product from the vending machine immediately after identification. Bluetooth, for example, is an additional communications link of this type.

For example, the vending machine at which the food product is waiting for pickup and the mobile phone of the consumer communicate over the near field communication system or via Bluetooth, for example the customer number of the consumer, his mobile number, an identification number of the SIM card in the mobile phone and/or an identification of the ordering program installed on the mobile phone being transmitted to the vending machine. This facilitates a unique identification of the consumer, ensuring that the food product is dispensed to the consumer who ordered and paid for it.

Other options for identifying the consumer are, for example, a fingerprint recognition system or an image analysis, i.e., with the aid of a camera installed, for example, on the vending machine, which facilitates, for example, face recognition, or, for example, an identification of an object or, for example, a symbol, image or pattern on a customer card, for example a bar code.

The particular type of identification and the features required therefore must be indicated, for example, when the order is placed or as early as the one-time registration process; for example, an image of the face of the consumer or his fingerprint must be transmitted to the central unit, or a customer card is issued to the consumer. Other ways to identify the consumer are, for example, personal identification documents, for example his ID card, passport or driver's license. This is facilitated, in particular, by machine-readable identification documents. In addition, for example, a credit card of the consumer may be used for identification, preferably the credit card that the consumer used to pay for the food product.

For example, an input unit may also be situated on the vending machine for identifying the consumer, via which the consumer may enter, for example, his customer number, his password or another identification code. If this input unit is designed, for example, as a touch-sensitive screen or is coupled with a screen, ads, for example for newly available food products, may also be output to the consumer via this screen. A combination of multiple identification devices is also possible.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the sole figure shows a schematic representation of an embodiment of a method for operating at least one vending machine.

### DETAILED DESCRIPTION

The figure shows a schematic representation of one embodiment of a method for operating at least one vending machine V for preparing and dispensing food products to consumers K. The method enables the consumer a remote order of the food product to be prepared and dispensed by vending machine V, i.e., vending machine V is remotely operated or remote-controlled by consumer K. Remotely operated, remote-controlled or a remote order means that consumer K is in a geographic location other than the location of vending machine V during the ordering process, so that he has no direct physical contact with vending machine V for the purpose of operating vending machine V with the aid of control elements disposed thereon.

The food product to be dispensed may be, for example, pizza or another food product which is stored, for example in frozen form, in vending machine V. and is to be prepared by vending machine V, i.e., for example, defrosted and heated and, for example, cooked. For this purpose, vending machine V has, for example, a microwave and/or an oven, for example, with top heat and bottom heat. After it has been prepared, the food product is to be dispensed to consumer K by vending machine V.

Vending machine V advantageously has a storage container in which a plurality of identical or different food products are to be stored, which are to be prepared according to an order placed by particular consumer K and which are to be dispensed to particular consumer K. This preferably takes place automatically, i.e., the particular food product is automatically removed from the storage container, prepared and transported, for example, to a dispensing compartment, from which it may be removed by particular consumer K.

Vending machine V is connected over a first communications link KV1 to a central unit Z. for example a host computer, server or data center of a vending service provider, i.e., an operator of vending machine V. First communications link KV1 may have a wired or wireless design, or it may have both wired and wireless sections.

Central unit Z may also be connected to additional vending machines V, which are not illustrated herein, over additional first communications links KV1, also in a wired manner or wirelessly, thereby forming a network between central unit Z and vending machines V. This network may be designed, for example, as a master/slave network, central unit Z being the master and vending machines V connected thereto being the slaves. However, other network configurations are also possible. First communications link KV1 or the plurality of first communications links KV1 is/are preferably designed to be bidirectional, as in the example illustrated herein, i.e., it is possible to transmit information from central unit Z to particular vending machine V as well as to transmit information from particular vending machine V to central unit Z.

For example, information about a current fill status of vending machine V with respect to food products, which are identifiable, for example, on the basis of a lot number, may be transmitted to central unit Z. The dispensing time of the food products and the particular type of food product dispensed may furthermore be transmitted to central unit Z, so that a demand and its distribution over time as well as the product selection of vending machine V. for example, may be monitored at any time in central unit Z. The filling of vending machine V with new food products may then be planned in a timely fashion on the basis of the data transmitted by vending machine V, for example with respect to the fill status. During filling, the filled food products are advantageously scanned, for example using bar codes, and reported to central unit Z.

Consumer K is at least temporarily connected to central unit Z over a second communications link KV2. This second communications link KV2 may also have a wired or wireless design, or it may have both wired and wireless sections. This second communications link KV2 is also advantageously designed to be bidirectional, so that a transmission of information from consumer K to central unit Z as well as a transmission of information from central unit Z to consumer K are facilitated, i.e., an exchange of information between consumer K and central unit Z is facilitated. An indirect transmission of information, i.e., with central unit Z as the intermediary, from consumer K to vending machine V and advantageously also an indirect transmission of information of this type from vending machine V to consumer K are facilitated in this manner over second communications link KV2, central unit Z and first communications link KV1.

In another embodiment, which is not illustrated herein, a direct communication between consumer K and vending machine V may also be facilitated, i.e., a direct communications link between vending machine V and consumer K would exist, at least temporarily, which is also preferably designed to be bidirectional and which has a wired or wireless design or both wired and wireless sections. This arrangement would facilitate a direct transmission of information from consumer K to vending machine V and advantageously from vending machine V to consumer K, i.e., a direct exchange of information therebetween.

In the exemplary embodiment of the method for operating vending machine V illustrated herein, the food product to be prepared by vending machine V and dispensed to consumer K, for example a pizza, is remotely ordered by consumer K over second communications link KV2. This order is accepted by central unit Z and transmitted to vending machine V over first communications link KV1. Vending machine V is remotely operated by consumer K in this manner, i.e., consumer K communicates with vending machine V via central unit Z.

The communication via central unit Z is particularly advantageous if central unit Z is connected to a plurality of vending machines V over first communication links KV1. With the aid of a network of this type, consumer K gains access to all vending machines V in the network and may, for example, select for his order vending machine V situated in the most convenient location for him or vending machine V containing the food product desired by consumer K or having the most attractive food product price.

The method makes it possible for consumer K to place his order when he is still at a great distance from vending machine V, so that, in this manner, the time it takes for consumer K to reach vending machine V, i.e., the period of time consumer K needs to cover a distance to vending machine V, may be used to prepare the food product. In particular, the heating of food products, particularly if they are stored in frozen form in vending machine V, requires a longer preparation time, for example for defrosting, heating and furthermore possibly for cooking the food product. Due to the remote ordering process, therefore, consumer K avoids long waiting times at vending machine V.

Moreover, consumer K is easily informed in this manner of which food products are sold in vending machine K and for what food product price. Consumer K thus avoids unnecessary trips to vending machine V, since he goes to vending machine V only if the order was successful and not if vending machine V does not offer the food products consumer K wishes to have.

Consumer K preferably orders the food product over an Internet connection and/or over a mobile communications link, i.e., second communications link KV2 is designed as such. The order may be placed, for example, from a mobile or stationary computer or a mobile phone. If the order is placed over the Internet, a website, for example, is made available to consumer K by central unit Z, which consumer K may use to enter his order on a corresponding input screen. Alternatively, it is also possible, for example, to place the order over the phone, the order then being transmitted by an order handler to central unit Z or directly to vending machine V over first communications link KV1.

Consumer K advantageously registers on a one-time basis to permit orders to be placed by transmitting user data and/or by installing an ordering program on a mobile or stationary computer or a mobile phone. This is a one-time registration for consumer K, i.e., consumer K registers in this manner as a user of the method or the ordering system and may thereafter always be uniquely identified by logging in with his registered user data, i.e., by logging in with his registered user data, for example, on a website of the vending service provider or by activating the ordering program. An ordering program of this type may be, for example, a so-called app, i.e., a corresponding application program which is installed, in particular, on mobile phones designed as so-called smart phones.

If consumer K registers by transmitting user data, advantageously to central unit Z, the transmission being able to take place, for example, over the Internet, for example via a website of central unit Z using a corresponding input screen, or, for example also over the phone, for example via a so-called call center, the consumer's last name and first name, date of birth, mobile number, i.e., the phone number of his mobile phone, e-mail address, preferred method of payment and/or declaration of consent with respect to use conditions, for example, are collected as user data. In particular, the permission of consumer K is necessary if, for example, a current position of consumer K is to be determined, for example using mobile telephone geolocation.

During the one-time registration, consumer K is assigned, for example, a unique customer number which may be used to identify him when he places an order. Other or additional identifying features may also be, for example, his transmitted user data, in particular, for example, his e-mail address and/or his name and/or his date of birth. If an order is placed via the installed ordering program, the mobile phone of consumer K. for example, may be used for identification, for example by transmitting his mobile number and/or an identifier of a SIM card installed in the mobile phone.

By specifying the user data, a customer account, for example, may also be created, in which points or cash amounts, for example, may be credited to consumer K. depending on his orders. Consumer K may also be notified of a discount action, for example via his mobile phone or e-mail address.

Credit card payments, direct debits, bank transfers, payments via an online payment system with or without using the mobile phone, for example billing via a mobile phone bill, are possible as preferred means of payment or payment options. The payment is advantageously made immediately at the time the order is placed, advantageously automatically by using the preferred means of payment specified by consumer K. In this manner, the order is carried out only after payment, which prevents, for example, vending machine V from becoming clogged with prepared food products waiting to be dispensed if consumer K fails to pay. This would result in the fact that no additional food products could be prepared and dispensed to additional consumers K. since the dispensing compartment of vending machine V would be blocked by the prepared food products which failed to be picked up.

Alternatively, of course, consumer K also has the option, for example, of paying cash directly at vending machine V immediately before the food product is dispensed. In this case, however, the danger of vending machine V becoming clogged arises if consumer K is unable to pay and the food product is therefore retained in vending machine V, and the dispensing compartment is blocked.

A type of food product, a time at which the food product is dispensed from vending machine V and/or a location of vending machine V at which the order is to be processed is/are specified by consumer K as order attributes and transmitted over second communications link KV2 to central unit Z, which then transmits the information over first communications link KV1 to the vending machine V, indicating that the latter is to prepare the ordered food product, whereby vending machine V begins preparing the food product in good time to dispense the food product to consumer K at the predefined dispensing time. A time for starting the preparation, for example, may be transmitted by central unit Z, i.e., the starting time is calculated in central unit Z as a function of a particular preparation time, or the dispensing time is transmitted to vending machine V, so that the starting time is determined in vending machine V as a function of the particular preparation time.

If the installed ordering program is used, the order attributes are requested automatically, so that consumer K may enter the appropriate order attributes, which are then transmitted to central unit Z over second communications link KV2. If an order is placed over the Internet, for example via the website of the central unit, an input screen for accepting the order includes corresponding input fields to be filled in. The order attributes entered by consumer K are then transmitted to central unit Z over second communications link KV2.

By indicating a location of a vending machine V preferred by consumer K, if a plurality of vending machines V are available, consumer K may select, for example, a vending machine V in a location which he is able to reach quickly and conveniently or a vending machine V which has his preferred food product or which has a particularly attractive food product price. The indication of the dispensing time allows the preparation of the food product to begin in such a way that it is finished when the dispensing time is reached. This avoids consumer K having to wait for a long time at vending machine V. This furthermore avoids vending machine V from becoming clogged by a food product which is prepared too early and which then remains in the dispensing compartment of vending machine V until consumer K picks it up, thereby preventing additional food products from being able to be dispensed. Afresh preparation of the food product is also ensured thereby, so that an optimum temperature is ensured and, for example, the food product does not have to be kept warm. This makes it unnecessary to provide, for example, a unit for storing and keeping food warm in vending machine V, whereby vending machine V may have a simpler, smaller and more economical design.

Information about a current status of his order is preferably transmitted to consumer K. This information may be sent to consumer K over second communications link KV2 over which he ordered the food product or over another communications link. As a result, consumer K preferably receives an order confirmation to verify his order immediately after the order is placed, for example by e-mail or in the form of a message transmitted to his mobile phone, for example an SMS text message.

Additional information may furthermore be sent to consumer K, who is then able to select this information, for example, when placing the order or during the one-time registration process. For example, reminder messages are thus transmitted to consumer K in order to thereby ensure that he picks up the food product which he has ordered and which was prepared by vending machine V in good time to prevent vending machine V from being clogged thereby. A point in time for a reminder message of this type may be specified, for example 15 minutes before the dispensing time of the food product, or it may be defined by consumer K. This reminder messages may also be transmitted to consumer K, for example as an e-mail or SMS text message.

Consumer K is furthermore preferably notified if the dispensing time he has requested cannot be met, for example due to particularly high demand, since other orders must first be processed. In this case, consumer K is preferably notified of a new dispensing time for his food product, so that he does not have to wait unnecessarily at vending machine V for his food product.

In one preferred embodiment of the method, a current position of consumer K is determined. This may be done, for example, by determining the position of his mobile phone, for example via a position determining function of his mobile telephone with the aid of a global navigation satellite system for determining the position or with the aid of a position determining system by determining cells of a mobile network where the mobile telephone is currently registered. The determined position is then transmitted from the mobile phone of consumer K to central unit Z or, in other exemplary embodiments, directly to vending machine V. To determine the position of consumer K by determining the cells of the mobile network where the mobile phone of consumer K is currently registered, central unit Z may access, for example, information of a mobile network carrier.

In this manner, it may be established, for example, whether it will be possible for consumer K to reach vending machine V he selected while placing the order at the dispensing time he specified while placing the order. Consumer K is thereby preferably warned if he is too far away from a vending machine V he has selected in order to reach vending machine V before the time he has specified for dispensing the food product. In other words, the determined current position of consumer K is used to predict a point in time at which the consumer will reach a vending machine V he has selected. This predicted point in time is automatically compared with the dispensing time specified by consumer K, and consumer K is automatically warned if the predicted point in time is later than the dispensing time he has specified.

This warning is advantageously given during the placement of the order in the form of a corresponding alert. This makes it possible to cancel or reject the order, or at least to adjust the dispensing time accordingly, or another vending machine V may be selected which the consumer is able to reach more quickly. This once again avoids vending machine V from being clogged by a prepared food product which is waiting in the dispensing compartment for dispensing to consumer K and which is not picked up by consumer K on time. In other words, the position determining function and the prediction of the point in time at which consumer K would reach the vending machine are carried out during the ordering process.

In one advantageous embodiment, the preparation of the food product in vending machine V is only started when consumer K has reached a predefined distance to the vending machine V or is closer than a predefined distance. This is particularly advantageous when using the function for determining the position of consumer K, since in this case no fixed time for dispensing the food product needs to be specified, and instead the preparation of the food product is not started until consumer K has reached a sufficient distance from vending machine V to allow consumer K to pick up the food product at vending machine V in this manner, as soon as possible after the preparation has finished. This is made possible, for example, by redetermining the position of consumer K continuously or at predetermined time intervals and transmitting it to central unit Z or, in other exemplary embodiments, directly to vending machine V via the consumer's mobile phone.

In this manner, a clogging of vending machine V by a prepared food product which is waiting in the dispensing compartment to be picked up by consumer K and which will be picked up only with a long delay because consumer K is too far away from vending machine V. As described above, this would hinder, i.e., cause a delay in processing, subsequent orders by vending machine V, and thereby inconvenience other consumers K. In addition, the prepared food product would get cold in the dispensing compartment. This is prevented by preparing the food product in coordination with the position of consumer K. Moreover, this means that no unit for dispensing and keeping food warm needs to be provided in vending machine V so that vending machine V may have a smaller, simpler and more economical design.

This also allows for optimum use of vending machine V, since the orders are processed not according to their receipt or according to dispensing time specified by consumer K but instead according to the proximity of particular consumer K to vending machine V. In other words, the system processes the order of consumer K who is located the shortest distance from vending machine V and who is therefore able to pick up the finished food product ready for dispensing the soonest. This reduces the waiting times for consumers K or eliminates them entirely.

These advantages may also be alternatively or additionally achieved by the fact that the time for dispensing the food product from vending machine V is predicted with the aid of the determined current position of consumer K. This time corresponds to the predicted point in time at which consumer K reaches vending machine V. Taking into account the preparation time needed to prepare the food product, the preparation of the food product is then started in good time before the predicted dispensing time. This has the advantage that the position of consumer K does not have to be determined constantly or multiple times. For example, a one-time position determination is enough. A multiple or continuous position determination is, of course, advantageous in order to check the prediction of the dispensing time and make it more precise, in order to thereby enable the preparation to start on time and to optimize the dispensing time of the food product. As a result, the preparation of the food product has preferably finished by the time consumer K arrives at vending machine V, and the food product is dispensed to consumer K so that no waiting time arises for consumer K, and vending machine V is not clogged with food products that have not yet been picked up. Once again, the orders may be processed by vending machine V in the order of the predicted dispensing times.

A food product price is preferably determined as a function of at least one predefined parameter and communicated to consumer K over second communications link KV2 during the ordering process. This is an alternative to a predefined fixed price at which the submitted orders are then processed in sequence. This may result in longer waiting times for consumers K, particularly if there is high demand. Adjusting the food product price, for example, to the particular selection and the particular demand may avoid this circumstance, since demand may be increased by a price reduction at times of low demand, and demand may be reduced by correspondingly increasing the price at times of high demand, thereby avoiding excessively long waiting times for consumers K.

The food product price may be different for different food products available in vending machine V, and it may be adjusted differently, so that a correspondingly lower food product price may be set, for example, for food products for which there is less demand or for food products whose sell-by date will soon expire. In a plurality of available vending machines V, the food product prices of the same food products may also be different in different vending machines V at the same time, for example depending on the supply and demand at particular vending machine V. This may redirect consumers K, for example, to a more remote vending machine V, if consumers K are prepared to travel a greater distance to pick up the food product in order to obtain it at a correspondingly more attractive food product price.

In other words, parameters for determining the particular food product price for available food products are, for example, a particular selection of a particular food product, a particular demand for this food product, inventories of the particular food product in vending machine V and their sell-by dates as well as a location of particular vending machine V. Some or all of these parameters may be transmitted, updated in each case, to central unit Z over first communications link KV1, so that the current food product prices in each case are determined in central unit Z for the different food products in different vending machines V, and these prices may be communicated to consumer K while he is placing the order over second communications link KV2.

In addition, a parameter of this type for determining the particular food product may also be, for example, the setting of a fixed dispensing time or the variable determination of the dispensing time as a function of the current position of consumer K. In the case of high demand, in particular, it is advantageous to begin preparing the particular food product only when consumer K is located sufficiently near vending machine V to allow him to pick up the food product as soon as possible after it is prepared. If this option is selected, the food product price is therefore preferably less fixed than in the case of a permanently predefined dispensing time, at which the danger of vending machine V being clogged by a late pickup of the food product and a resulting inconvenience to subsequent consumers K is much greater. In other words, if particular consumer K consents to have his current position determined by his mobile phone and transmitted to central unit Z or directly to vending machine V, he receives the food product at a more attractive price.

Consumer K is conveniently identified with the aid of at least one consumer identification unit for dispensing the prepared food product. This consumer identification unit may be, for example, part of vending machine V or situated in the direct vicinity of vending machine V and coupled therewith. For example, a so-called near field communication (NFC) system (German: Nahbereichskommunikation) may be used to identify consumer K at vending machine V. It is furthermore possible to use other wireless or wired communications links, which, however, preferably have only a short range, in order to thereby determine that consumer K is located in the direct vicinity of vending machine V in order to remove the food product from vending machine V immediately after identification. Bluetooth, for example, is an additional communications link of this type.

For example, vending machine V at which the food product is waiting for pickup and the mobile phone of consumer K communicate via Bluetooth or the near field communication system, the customer number of consumer K, his mobile number, an identification number of the SIM card in the mobile phone and/or an identification of the ordering program installed on the mobile phone being transmitted to vending machine V. This facilitates a unique identification of consumer K, ensuring that the food product is dispensed to consumer K who ordered and paid for it.

Other options for identifying consumer K are, for example, a fingerprint recognition system or an image analysis, for example with the aid of a camera installed on vending machine V, which facilitates, for example, face recognition, or, for example, an identification of an object or, for example, a symbol, image or pattern on a customer card, for example a bar code.

The particular type of consumer identification system and the features required therefor must, for example, be indicated when the order is placed or as early as the one-time registration process; for example, an image of the face of consumer K or his fingerprint must be transmitted to central unit Z, or a customer card is issued to consumer K. Other ways to identify consumer K are, for example, personal identification documents, for example his ID card, passport or driver's license. This is facilitated, in particular, by machine-readable identification documents. In addition, for example, a credit card of consumer K may be used for identification, preferably the credit card that consumer K used to pay for the food product.

For example, an input unit may also be situated on vending machine V for identifying consumer K, via which consumer K may enter, for example, his customer number, his password or another identification code. If this input unit is designed, for example, as a touch-sensitive screen or is coupled with a screen, ads, for example for newly available food products, may also be output to consumer K via this screen. A combination of multiple identification devices is also possible.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating at least one vending machine, the method comprising:
providing a food product to prepared by the vending machine and dispensed to a consumer;
remotely ordering the food product by the consumer over at least one wireless and/or wired communications link;
transmitting the order to the vending machine over the same or an additional wireless and/or wired communications link; and
determining a current position of the consumer;
wherein a point in time at which the consumer reaches a vending machine selected by him being predicted with the aid of the determined current position of the consumer, the consumer being warned if the predicted point in time takes place after the dispensing time he has specified, and/or the preparation of the food product in the vending machine not being started until the consumer has reached or is closer than a predefined distance from the vending machine and/or the time for dispensing the food product from the vending machine being predicted with the aid of the determined current position of the consumer.

2. The method according to claim 1, wherein the consumer orders the food product over an Internet connection and/or over a mobile communications link.

3. The method according to claim 1, wherein the consumer registers on a one-time basis to permit orders to be placed by transmitting user data and/or by installing an ordering program on a mobile or stationary computer or a mobile phone.

4. The method according to claim 1, wherein a type of food product, a time at which the food product is dispensed from the vending machine, and/or a location of the vending machine where the order is to be processed are requested as order attributes and specified by the consumer.

5. The method according to claim 1, wherein information about a current status of the order is transmitted to the consumer.

6. The method according to claim 1, wherein a food product price is determined as a function of at least one predefined parameter and communicated to the consumer during the ordering process.

7. The method according to claim 1, wherein the consumer is identified for dispensing the prepared food product with the aid of at least one consumer identification unit in the vicinity of the vending machine.
